(19) United States
(12) Patent Application Publication
(10) Pub. No.: US 2009/0242106 A1
(43) Pub. Date: Oct. 1, 2009

(54) PRE-OPERATIVE SURGICAL SITE MARKING WITH A TEMPORARY CUSTOMIZABLE TATTOO

(76) Inventor: Michael E. Kupferman, Houston, TX (US)

Correspondence Address: FULBRIGHT & JAWORSKI L.L.P., 600 CONGRESS AVE., SUITE 2400, AUSTIN, TX, 78701, US

(21) Appl. No.: 12/397,677

(22) Filed: Mar. 4, 2009

Related U.S. Application Data
(60) Provisional application No. 61/034,855, filed on Mar. 7, 2008.

(51) Int. Cl. B44C 1/17; B32B 33/00

(52) U.S. Cl. 156/230; 428/41.7

(57) ABSTRACT

The present invention provides devices and methods for clearly and consistently marking a patient prior to a procedure. In particular, the invention provides a temporary tattoo for marking a patient at a site of a procedure. The tattoo may indicate any information that would be helpful to a medical practitioner clearly and consistently mark a patient for a procedure. In some embodiments, the tattoo may indicate types of information including, but not limited to, information indicative of the laterality of the procedure, the type of procedure, the medical practitioner, the institution, or the department. In certain embodiments, the tattoo may indicate the location of the procedure with a “yes”. In other embodiments, the invention provides a method for marking a patient at the site of a procedure.

### CROSS-REFERENCE TO RELATED APPLICATIONS

This applications claims the priority of U.S. Provisional Patent Application Ser. No. 61/034,855, filed Mar. 7, 2008, the entire disclosure of which is specifically incorporated herein by reference.

### BACKGROUND OF THE INVENTION

A. Field of the Invention

The present invention relates generally to the field of medical devices. More particularly, it concerns devices and methods for clearly and consistently marking a patient prior to a procedure.

B. Description of Related Art

Wrong site surgery is a major concern for hospitals, physicians and national and federal regulatory agencies. No approach currently available effectively allow a surgeon or physician to clearly and consistently mark the patient in the clinic prior to the day of surgery or invasive procedure.

Previously, marking pens have been used on patients to mark on a patient's body the proper place for a procedure to be performed. However, with the use of these marking pens, it is often difficult to provide uniform and legible handwritten markings. Accordingly, the use of such hand written marks may result in potentially ambiguous and unclear markings that may lead to confusion during the procedure.

One alternative method for marking a patient is described in U.S. Pat. Nos. 5,306,271, 5,407,440, and 5,743,899 all to Zinreich et al., all of which are incorporated herein by reference. This method provides for radiation therapy marking that employs skin markers that include an adhesive surface, so the markers may be releasably attached to a patient's skin surface. However, the tape-like markers may be readily removed intentionally or accidentally, which can lead to loss of the marker or re-adherence to an improper location or to another patient.

U.S. Pat. No. 6,286,682, which is incorporated herein by reference, provides for a method of marking a patient that provides for a one-time use semi-permanent skin marker having an adhesive substrate for communicating various information such as previous surgeries, pre-existing conditions, or current medications. A similar method for marking a patient is described in U.S. Pat. No. 6,833,128, which provides a method for monitoring local reactions associated with injection sites that utilizes a temporary tattoo. U.S. Pat. No. 6,286,682 and U.S. Pat. No. 6,833,128 are both incorporated herein by reference in their entirety.

U.S. Pat. No. 6,800,122 provides for permanent markings that are designed in advance to be easily changed and/or removed on demand. In particular, these markings are created using indispersible microparticles designed with one or more specific properties, such as electromagnetic and/or structural properties, that allow the microparticles to be altered or removed. However, removal of these markings require exposure to a specific energy and therefore is difficult for an individual to remove the marking.

U.S. Patent Publications 2005/0234322 and 2007/0055290, both of which are herein incorporated by reference in their entirety, provide an image transfer marking assembly for indicating the proper location of a surgical procedure to be performed. The assembly comprises a print member having a print face sized and shaped to define a mirror image of a desired image to be transfer printed onto a surgical patient in a manner indicative of a surgical site location. This assembly requires the print face to be loaded with a desired marking agent, which could lead to the image being distorted during application.

There is therefore a need for a marking device which enables a medical practitioner to consistently place a professional looking, uniform, and unambiguous marking onto a patient in order to quickly and clearly designate the correct location for a desired medical procedure.

### SUMMARY OF THE INVENTION

In one embodiment, the invention provides a temporary tattoo for marking a patient at a site of a procedure comprising a porous paper base; a water-soluble slip layer on at least one surface of the paper base; a water resistant film carried on said water soluble slip layer; printed matter on said water resistant film, wherein the printed matter comprises symbols and/or letters that indicate the location of the procedure; a spot coating covering the printed matter; a layer of pressure sensitive adhesive covering the spot coating; and a removable protective cover sheet on the layer of pressure sensitive adhesive. In some embodiments, the tattoo may be sterile to prevent any undesirable effects, such as infection.

The printed matter may indicate any information that would be helpful to a medical practitioner clearly and consistently mark a patient for a procedure. In some embodiments, the printed matter indicates the location of the procedure with a “yes”. In other embodiments, the printed matter may indicate types of information including, but not limited to, information indicative of the laterality of the procedure, the type of procedure, the medical practitioner, the institution, or the department. The indication of the medical practitioner may be, for example, the initials or signature of the medical practitioner. Additional examples of information that may be provided on the tattoo include an insignia, a photo of the body site, and/or an indication of the organ, vessel, joint, digit number. In some embodiments, the printed matter may include one, two, three, four or more types of information. The printed matter may be in any size or any font.

In some embodiments, the tattoo may further indicate the date of the procedure, the date of placement of the tattoo, or both. In such embodiments, the tattoo should further comprise a clear coat over the tattoo to prevent distortion of the indicated dates.

The medical practitioner may be any medical professional who is performing or participating in a procedure performed on a patient. Some non-limiting examples of a medical practitioner are a surgeon, a proceduralist, a physicians assistant, or a preoperative registered or unregistered nurse. The procedure may be any invasive or non-invasive procedure performed by a medical practitioner. Examples include surgeries, including but not limited to intracranial, head and neck-extracranial, intrathoracic, intra-abdominal, vascular, cardiac, gastrointestinal, pulmonary, limb\digits, ophthalmic, otolaryngologica, rheumatologic, orthopaedic, cutaneous\dermatological, breast, pelvic, gynecological and dental. Examples of other procedures include endoscopies, including but not limited to bronchoscopy and bronchoscopic-assisted procedures, gastrointestinal endoscopy and gastrointestinal-endocscopic-assisted procedures, neuro-endoscopic and arthoscopic procedures.

In another embodiment, the current invention provides a method for marking a procedural site on a patient comprising placing a temporary tattoo on the body of the patient at or near the site of the procedure. In some aspects, the procedure may be a surgery. The tattoo may be placed on the body of the patient by a medical practitioner. In some embodiments, the medical practitioner may be a surgeon, a proceduralist, a physicians assistant, or a preoperative registered or unregistered nurse. In particular embodiments, two or more tattoos are placed on the body of the patient.

It is contemplated that any method or composition described herein can be implemented with respect to any other method or composition described herein.

The use of the term “or” in the claims is used to mean “and/or” unless explicitly indicated to refer to alternatives only or the alternatives are mutually exclusive, although the disclosure supports a definition that refers to only alternatives and “and/or.”

Throughout this application, the term “about” is used to indicate that a value includes the standard deviation of error for the device or method being employed to determine the value.

Following long-standing patent law, the words “a” and “an,” when used in conjunction with the word “comprising” in the claims or specification, denotes one or more, unless specifically noted.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a cross-sectional view of a temporary tattoo made in accordance with the present invention.

FIGS. 2A-D are illustrative examples of printed matter that may be present on a temporary tattoo made in accordance with the present invention. FIG. 2A indicates the medical practitioner, the department, and the institution. FIG. 2B indicates the laterality of the procedure, the medical practitioner, the department and the institution. FIGS. 2C-D indicate the institution, the medical practitioner, the department, and a “YES!”.

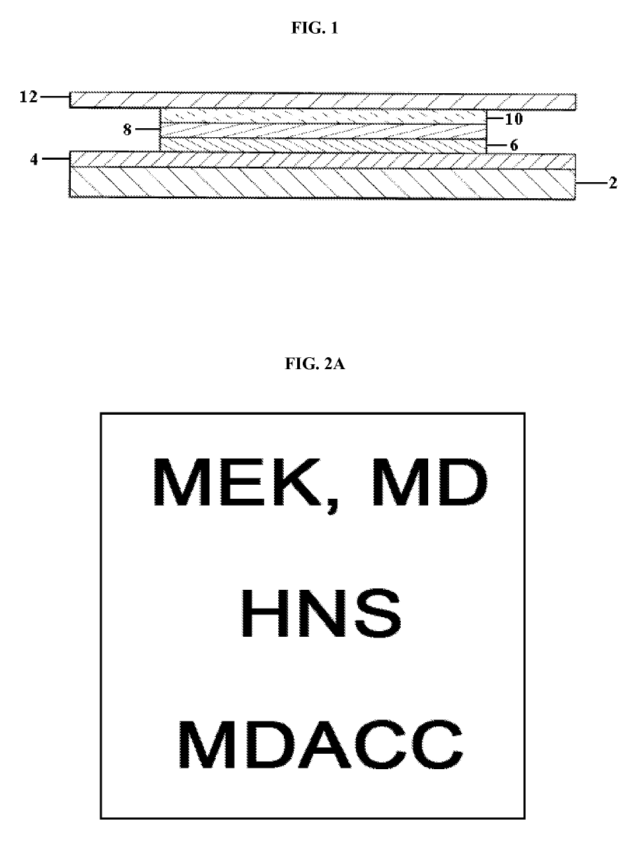

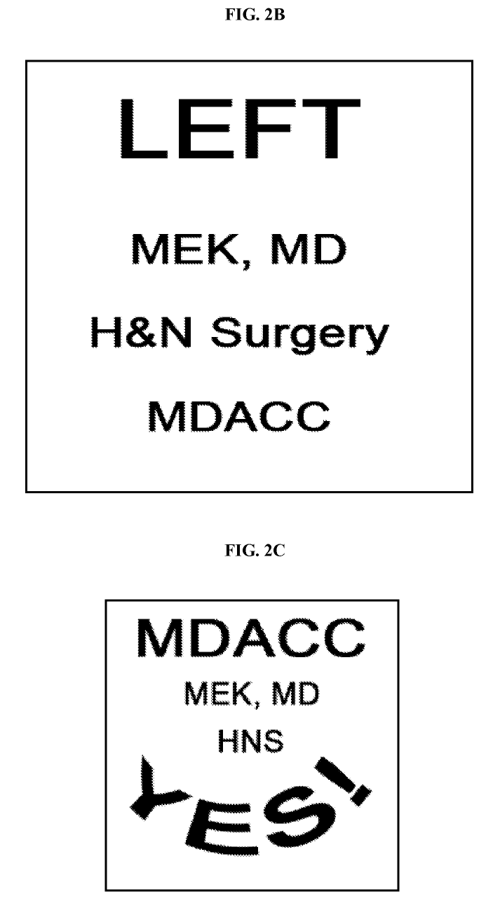

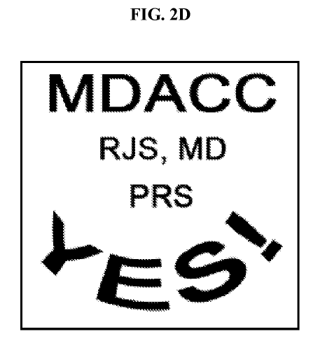

### DESCRIPTION OF ILLUSTRATIVE EMBODIMENTS

The present invention provides a customizable temporary tattoo that contains information about a procedure to prevent wrong site surgery and to allow compliance with Joint Commission on the Accreditation of Healthcare Organizations (JCAHO) regulations on pre-operative site marking.

The tattoo may indicate a wide variety of information relevant to a procedure that may be helpful to the medical practitioner in preventing wrong site or wrong procedure surgery. This information can include, but is not limited to, the laterality of the procedure, the type of procedure, the medical practitioner, the institution, the department, a logo, and/or a “YES!”. When multiple structures are involved, such as fingers and toes, or multiple levels, such as during a spinal procedure, the marking may include an indication of the correct structure or level. Additional examples of information that may be provided on the tattoo include the medical practitioner's signature or initials, an insignia, a photo of the body site, and/or an indication of the organ, vessel, joint, digit number. In some embodiments, the tattoo may provide the date the tattoo was placed on the patient or the date the procedure is to be performed. In such a situation, it may be important to cover the tattoo after marking the date with a clear coat to prevent the date marking from being distorted.

The tattoo may be placed on any part of the body that a procedure may be performed on. In particular, it is preferable that the tattoo be visible once a patient has been prepped and draped for the procedure. The tattoos may be used in a wide variety of situations, for example to mark the location of any invasive or non-invasive procedure performed by a medical practitioner. Examples include surgeries, including but not limited to intracranial, head and neck-extracranial, intrathoracic, intra-abdominal, vascular, cardiac, gastrointestinal, pulmonary, limb\digits, ophthalmic, otolaryngologica, rheumatologic, orthopaedic, cutaneous\dermatological, breast, pelvic, gynecological, and dental. Other examples include endoscopies, including but not limited to bronchoscopy and bronchoscopic-assisted procedures, gastrointestinal endoscopy and gastrointestinal-endocscopic-assisted procedures, neuro-endoscopic and arthoscopic procedures. In some embodiments, the tattoo may be used for procedures performed through a natural body orifice, such as the mouth, nose, vagina, anus or urethra. In such embodiments, the tattoo may be placed at or near the insertion site and should indicate the laterality of the procedure, if relevant.

Temporary tattoos for application to skin are known in the art. See, for example, U.S. Pat. No. 4,522,864 issued to Humason, which is incorporated by reference in its entirety. Humason teaches a decal having a porous paper backing, a water-soluble slip layer on the surface of the paper backing, a microscopically thin, flexible, extensible, water-resistant film covering the slip layer, a very thin translucent multi-color design offset (lithographically) printed on the water-resistant film, and a uniform layer of transparent or translucent pressure sensitive adhesive covering the design. Similar teachings are set forth in U.S. Pat. No. 1,627,407; U.S. Pat. No. 2,578,150; U.S. Pat. No. 2,941,916; U.S. Pat. No. 4,175,151; and U.S. Pat. No. 6,074,721, all of which are incorporated by reference in their entirety.

The temporary tattoo uses a porous paper base 2 coated on at least one side with a water-soluble slip layer 4, which may be, for example, dextrin gum. A water resistant film comprising printed matter 6, where the printed matter may be monochrome or multicolor, is directly printed onto the slip layer 4 by offset printing. The offset printing inks should be made with pigments that are certified by the FDA for use in drugs and cosmetics. Such inks are available in a variety of colors. The offset inks are printed directly on the slip layer 4 in designated image areas by means of a conventional offset printing press using ink and water. Lithographic presses suitable for such printing are capable of printing up to eight colors plus a coating in-line.

After the water resistant layer comprising printed matter 6 is applied, a spot coating 8 may be printed over the printed matter 6 areas with a matte or semi-gloss finish. Such a finish is important, since a glossy finish may be visibly apparent in areas around and in-between design elements of the printed matter 6, and may even show through transparent inks. A glossy finish may also make it difficult for a medical practitioner to read the information on the tattoo due to the glare produced by bright lights. In the preferred embodiment, the spot coating 8 closely conforms to the shape of the printed matter 6. However, the spot coating 8 may extend out somewhat around the printed matter 6 for additional coverage and into connecting areas between printed matter 6 that is part of the same overall design.

A pressure sensitive adhesive 10 is then spot printed over the spot coating 8. The spot coating 8 acts as a protective layer when the finished tattoo is applied to the skin. Without the spot coating 8 acting as a protective layer, the adhesive 10 would migrate through the printed matter 6, and the tattoo would feel tacky to the touch. Further, the tattoo would come off faster due to friction with the surrounding environment. Advantages of using the an aqueous coating material for the spot coating 8 include quick drying time, allowing for easier handling; less ink set off because of the quick drying time; and a thicker coating layer, which provides for greater protection against migration of the adhesive 10.

As is known in the art, the printed matter 6, spot coating 8, and adhesive 10 are printed with the images in reverse, so that the design will appear properly oriented after the decal is applied.

Lastly, a protective cover sheet 12, such as a silicone-coated paper, is placed over the adhesive 10 of each tattoo, in order to protect the tattoo images and to keep printed tattoos from sticking together. A suitable cover sheet is polypropylene.

To apply the tattoo, the protective cover sheet 12 would be removed from the tattoo and the adhesive 10 side of the tattoo would be placed on the skin. Before application, the area on the skin where the tattoo is to be placed is cleaned with an appropriate substance, such as alcohol, and dried. The tattoo should be placed on the prepared skin face down with firm pressure applied. Gauze, or a sponge, should then be saturated with water, and placed over the tattoo, again applying firm pressure over the entire area. Sterile gauze and sterile water should be used to prevent any undesirable effects, such as infection. The porous paper base 2 is saturated with water to dissolve the slip layer 4. When the slip layer 4 has dissolved, the porous paper base 2 can be removed from the tattoo by sliding or peeling it away from the tattoo, leaving the printed matter 6 in place on the skin.

### REFERENCES

The following references, to the extent that they provide exemplary procedural or other details supplementary to those set forth herein, are specifically incorporated herein by reference.
U.S. Pat. No. 1,627,407
U.S. Pat. No. 2,578,150
U.S. Pat. No. 2,941,916
U.S. Pat. No. 4,175,151
U.S. Pat. No. 4,522,864
U.S. Pat. No. 5,306,271
U.S. Pat. No. 5,407,440
U.S. Pat. No. 5,743,899
U.S. Pat. No. 6,074,721
U.S. Pat. No. 6,286,682
U.S. Pat. No. 6,800,122
U.S. Pat. No. 6,833,128
U.S. Publn. 2005/0234322
U.S. Publn. 2007/0055290

1. A temporary tattoo for marking a patient at a site of a procedure comprising:
(a) a porous paper base;
(b) a water-soluble slip layer on at least one surface of the paper base;
(c) a water resistant film carried on said water soluble slip layer;
(d) printed matter on said water resistant film, wherein the printed matter comprises symbols and/or letters that indicate the location of the procedure;
(e) a spot coating covering the printed matter;
(f) a layer of pressure sensitive adhesive covering the spot coating; and
(g) a removable protective cover sheet on the layer of pressure sensitive adhesive.

2. The tattoo of claim 1, wherein the printed matter indicates the location of the procedure with a “yes”.

3. The tattoo of claim 1, wherein the printed matter indicates a type of procedure, a medical practitioner, an institution, or a department.

4. The tattoo of claim 3, wherein the printed matter indicates a medical practitioner.

5. The tattoo of claim 4, wherein the indication of a medical practitioner is the initials of the medical practitioner.

6. The tattoo of claim 5, wherein the medical practitioner is a surgeon.

7. The tattoo of claim 1, wherein the tattoo further indicates a date of the procedure.

8. The tattoo of claim 7, further comprising a clear coat, wherein the clear coat is placed over the tattoo.

9. The tattoo of claim 7, wherein the tattoo further indicates a date of application of the tattoo.

10. The tattoo of claim 1, wherein the tattoo is sterile.

11. The tattoo of claim 1, wherein the printed matter indicates at least two types of information selected from information indicative of a type of procedure, a medical practitioner, an institution, or a department.

12. The tattoo of claim 11, wherein the printed matter indicates at least three types of information selected from information indicative of a type of procedure, a medical practitioner, an institution, or a department.

13. The tattoo of claim 12, wherein the printed matter indicates a type of procedure, a medical practitioner, an institution, and a department.

14. The tattoo of claim 13, wherein the printed matter indicates the location of the procedure with a “yes”, a type of procedure, a medical practitioner, an institution, and a department.

15. A method for marking a procedural site on a patient comprising placing the tattoo of claim 1 on the body of the patient at or near the site of the procedure.

16. The method of claim 15, wherein the procedure is a surgery.

17. The method of claim 15, wherein the tattoo is placed by a medical practitioner.

18. The method of claim 17, wherein the placement is performed by a surgeon.

19. The method of claim 17, wherein the placement is performed by a preoperative registered nurse.

20. The method of claim 15, wherein multiple tattoos are placed.
